(19) United States
(12) Patent Application Publication
(10) Pub. No.: US 2026/0054807 A1
(43) Pub. Date: Feb. 26, 2026

(54) Device for Lashing a Vehicle to a Loading Surface and Vehicle Having at Least One Such Device

(71) Applicant: Mercedes-Benz Group AG, Stuttgart (DE)

(72) Inventors: Frank HUMMEL, Eningen (DE); Alexander DEUTSCH, Stuttgart (DE); Thorsten PAUL, Leingarten (DE); René David GEIER, Burgstetten (DE)

(21) Appl. No.: 19/104,965

(22) PCT Filed: Sep. 13, 2023
(86) PCT No.: PCT/EP2023/075095

§ 371 Date: Feb. 19, 2025

(30) Foreign Application Priority Data
Oct. 5, 2022 (DE) 10 2022 003 683.5

(51) Int. Cl. B63B 69/00

(52) U.S. Cl. CPC B63B 69/00

(57) ABSTRACT

A device for lashing a vehicle to a loading surface includes a lashing ring and a fixing arrangement for fixing the lashing ring to a hub cap receptacle of a vehicle wheel of the vehicle. The fixing arrangement has a carrier insertable into the hub cap receptacle from an external side of the vehicle wheel and having a central passage opening, a threaded rod receivable in the opening, a clamping cone disposed on the threaded rod, a retaining plate having a central opening for the threaded rod, where the lashing ring is fixed to the retaining plate, and at least two locking elements. Each of the locking elements have an inner wall which corresponds to a frustoconical lateral surface of the clamping cone and an outer wall which corresponds to an inner opening wall of a region of a central opening of the vehicle wheel adjoining the hub cap receptacle.

### BACKGROUND AND SUMMARY OF THE INVENTION

The invention relates to a device for lashing a vehicle to a loading surface and to a vehicle.

A device for lashing vehicles to a loading surface is known from the prior art, as described in DE 20 2016 106 737 U1. The device comprises at least one lashing belt guided over a vehicle wheel, the lashing belt being equipped with at least one retaining means arranged on the loading surface, and a tensioning element acting on the lashing belt. In addition, at least one spring element is provided, the deformation of which functions as a gauge to measure lashing forces built up using the tensioning element.

In DE 10 2013 222 044 A1, a wheel rim cover is described. The wheel rim cover for a vehicle wheel for attachment to a vehicle wheel rim has at least one wing element for covering at least one portion of the wheel rim, which, depending on temperature, can take at least one first form and one second form. At least a part of the wing element is designed such that it is deformed axially away from the wheel rim when heated.

In DE 10 2022 002 497 A1, a wheel rim adapter system is disclosed, which serves to attach a stop element to a wheel rim and to lift a vehicle connected to the wheel rim.

DE 20 2004 003 314 U1 discloses an apparatus for lifting wheel drive vehicles, wherein a pipe section can be fastened to the wheel rim of a wheel, on one end of which pipe section a connecting element having an opening for receiving a hoist cable is arranged, and on the other end of which pipe section at least one coupling element having at least one hole for fixing the pipe section to a free end of an axle of the vehicle is arranged.

EP 2 127 971 A1 discloses a wheel rim, which is equipped with a stop element, via which a vehicle supported by the wheel rim can be lifted.

U.S. 3,061,354 A discloses a vehicle handling device for fixing to wheel mounting studs which is carried by a wheel hub of a vehicle, comprising tubular elements, for lifting or lashing the vehicle.

The internet site https://www.quora.com/How-do-F1-teams-transport-their-equipment-overseas discloses using the central hole of a wheel for lashing.

The object of the invention is to specify an improved device in relation to the prior art for lashing a vehicle to a loading surface, and a vehicle having at least one such device.

According to the invention, a device for lashing a vehicle to a loading surface has at least one lashing ring and a fixing arrangement for fixing the at least one lashing ring to a hub cap receptacle of a vehicle wheel of the vehicle in a form-fit manner. The vehicle wheel, or at least its wheel rim, can for example also be a component of the device.

A vehicle according to the invention has at least one such device. In particular, the vehicle has several such devices, in particular one such device for each vehicle wheel of the vehicle.

The device is in particular designed as a central sealing clamp, i.e., in a state mounted on the vehicle wheel, the fixing arrangement is clamped in a form-fit manner in a central opening of the vehicle wheel, in particular a wheel rim of the vehicle wheel. The hub cap receptacle, which is provided to receive a hub cap of the vehicle wheel, is a partial region of this central opening, in particular an outer partial region in the axial direction of this central opening, which partial region thus faces an external side of the vehicle wheel. The hub cap receptacle is a geometry of this partial region of the central opening designed to receive the hub cap. An inner region adjoins this partial region in the axial direction, the inner region thus facing an internal side of the vehicle wheel. The internal side of the vehicle wheel points in the direction of an axle of the vehicle, to which the vehicle wheel is fixed. The device, in particular its fixing arrangement, is a stable, in particular metallic, clamping mechanism, which is inserted into this central opening and is braced therein on the vehicle wheel, so that it is fixed in a form-fit manner, in particular in a form-fit manner in the axial direction of the central opening, to the vehicle wheel.

The device according to the invention, or more precisely the several devices according to the invention, which are respectively arranged on a vehicle wheel of the vehicle, make(s) it possible to safely lash the vehicle to its mode of transport, for example in a ship for ship transportation, without in the process damaging the vehicle, in particular its vehicle wheels. This is implemented in particular by means of at least one tie-down strap fixed to the respective lashing ring after the device is fixed to the vehicle wheel. To arrange the device, it is only necessary to remove the hub cap. At a transport destination, the device is then removed from the vehicle wheel again, and the hub cap is inserted into the hub cap receptacle.

In the prior art, this lashing is implemented, in particular in ship transportation, by tie-down straps, which are looped through spokes of the vehicle wheels. However, this is in particular problematic for aerodynamically optimized vehicle wheels, because they do not have regions between the spokes to pull the tie-down straps through. If the tie-down straps are still fixed to these vehicle wheels, the vehicle wheels, in particular their spokes and/or aerodynamic elements, can be damaged. This is avoided via the solution according to the invention.

An alternative known from the prior art is mounting other vehicle wheels for the transport of the vehicle, which make the lashing in the manner known from the prior art possible. These vehicle wheels must be exchanged again after the transport. Via the solution according to the invention, this complexity of exchanging the wheels twice is avoided.

It is in particular provided that the fixing arrangement has the following:
a carrier, which is designed such that it can be inserted in a form-fit manner into the hub cap receptacle from an external side of the vehicle wheel, and which has a central passage opening for receiving a threaded rod,
the threaded rod,
a clamping cone arranged on the threaded rod,
a retaining plate, to which the at least one lashing ring is fixed, is for example welded to the retaining plate, wherein the retaining plate has a central screw opening for screwing in the threaded rod, and
at least two locking elements.

In this embodiment, the clamping cone having the threaded rod and the locking elements can be arranged in the central opening of the vehicle wheel, the clamping cone and the locking elements are in particular in the region of the central opening adjoining the hub cap receptacle in the axial direction. The threaded rod protrudes outwards through the central opening, such that the carrier can be slid on and can be inserted into the hub cap receptacle, and the retaining plate can then be screwed onto the threaded rod. The carrier is thus fixed in the hub cap receptacle, and protects the wheel rim of the vehicle wheel against damage, because the retaining plate which rotates while being screwed on does not come into contact with the wheel rim, but only with the carrier. By screwing on the retaining plate, the threaded rod is pulled outwards, i.e., in the direction of the external side of the vehicle wheel, and in the process also pulls the clamping cone in this direction. The locking elements are arranged between the clamping cone and an inner diameter-reducing recess of the central opening of the vehicle wheel in this central opening, and are thus pressed radially outwards through the clamping cone in the central opening, and additionally against this diameter-reducing recess, until they abut against this diameter-reducing recess and against an inner opening wall of the central opening. If this is the case, the device, in particular the fixing arrangement, is braced on the vehicle wheel, i.e., is arranged in a form-fit manner in the central opening, and fixed therein. The carrier sits in the hub cap receptacle, and the retaining plate having the at least one lashing ring abuts against the carrier, and is fixed to the vehicle wheel via the threaded rod and the fixing arrangement.

In order to enable the fixing described to the vehicle wheel, it is in particular provided that the locking elements respectively have the following:
an inner wall, which is designed to correspond to a frustoconical lateral surface of the clamping cone, and
an outer wall, which is designed to correspond to an inner opening wall of the region of the central opening of the vehicle wheel adjoining the hub cap receptacle in the axial direction.

It is in particular provided that a sum of a largest external diameter of the clamping cone and of the, in particular radial, widths of the two locking elements is greater than a smallest internal diameter of the central opening of the vehicle wheel. This smallest internal diameter is in particular present at the diameter-reducing recess of the central opening.

In a possible embodiment, the threaded rod has an ejector recess, of which the diameter is greater than a diameter of a central receiving opening in the clamping cone for the threaded rod. This makes it possible to remove the device after the retaining plate is unscrewed by pushing the threaded rod back, i.e., in the direction of the axle of the vehicle and thus in the direction of the clamping cone, and thus to release the clamping cone from the locking elements. This makes it easier to release the clamping cone and the locking elements clamped by the latter in the central opening of the vehicle wheel.

In a possible embodiment, two lashing rings are provided, in particular fixed to the retaining plate. In particular, it is provided that the two lashing rings are fixed to the retaining plate rotated by 90° relative to each other. This makes it easier to align the tie-down strap. In particular, in the fixedly-screwed state, regardless of the respective position of the retaining plate, at least one of the two lashing rings is thus aligned in a position suitable for the tie-down strap.

It is in particular provided that the device is formed from metal, i.e., in particular, all components of the device are formed from metal. Secure bracing of the vehicle by means of the device is thus enabled.

Exemplary embodiments of the invention are explained in more detail in the following with reference to drawings.

### BRIEF DESCRIPTION OF THE DRAWINGS

FIG. 1 schematically shows a sectional depiction of a vehicle wheel of a vehicle having a device for lashing the vehicle to a loading surface; and

FIG. 2 schematically shows an aerial view from the front of the device.

### DETAILED DESCRIPTION OF THE DRAWINGS

Parts corresponding to one another are provided with the same reference numerals in all figures.

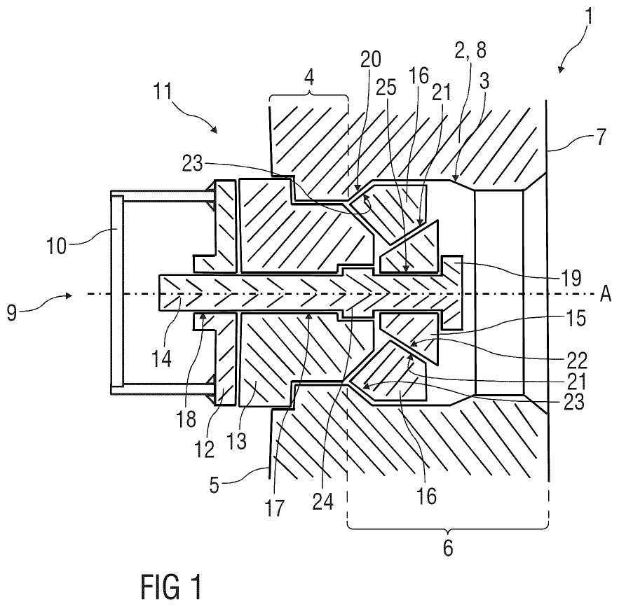

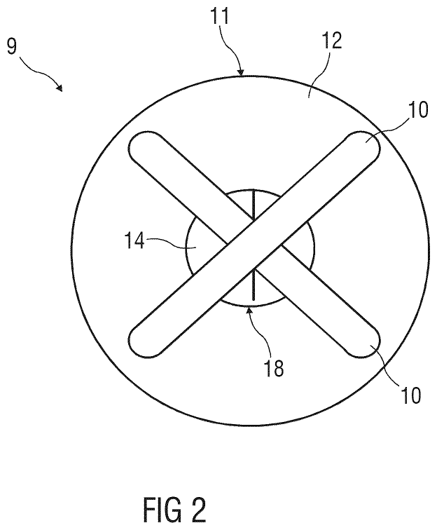

FIG. 1 shows a sectional depiction of a cutaway section of a vehicle 1 in the region of a vehicle wheel 2. FIG. 2 shows an aerial view of an external side 5 of the vehicle wheel 2. In both of the figures, a region of a central opening 3 of the vehicle wheel 2 is in particular depicted.

The central opening 3 has a hub cap receptacle 4, which is provided to receive a hub cap of the vehicle wheel 2. This hub cap receptacle 4 is a partial region of this central opening 3, in particular an outer partial region in the axial direction of this central opening 3, the partial region thus facing the external side 5 of the vehicle wheel 2. The hub cap receptacle 4 is a geometry of this partial region of the central opening 3 designed to receive the hub cap. An inner region 6 of the central opening 3 adjoins this partial region in the axial direction, the inner region thus facing an internal side 7 of the vehicle wheel 2. The internal side 7 of the vehicle wheel 2 points in the direction of an axle of the vehicle 1, to which the vehicle wheel 2 is fixed.

To be able to lash the vehicle 1, in particular for transportation, in particular without in the process damaging the vehicle wheel 2, in particular a wheel rim 8 of the vehicle wheel 2, a device 9 is provided for lashing the vehicle 1 to a loading surface of a means of transport, for example of a ship. This device 9 is already fixed to the vehicle wheel 2 in the example depicted.

The device 9 is a stable, in particular metallic, clamping mechanism, which is inserted into the central opening 3 of the vehicle wheel 2, and therein is braced on the vehicle wheel 2, so that it is fixed in a form-fit manner, in particular in a form-fit manner in the axial direction of the central opening 3, to the vehicle wheel 2.

The device 9 has at least one lashing ring 10 and a fixing arrangement 11 for fixing the at least one lashing ring 10 to the hub cap receptacle 4 of the vehicle wheel 2 of the vehicle 1 in a form-fit manner. In the depicted example, the device 9, as shown in FIG. 2, has two lashing rings 10, which are arranged rotated by 90° or approximately 90° to each other around the axis of rotation A of the central opening 3. The respective lashing ring 10 is fixed to a retaining plate 12 of the fixing arrangement 11 of the device 9, in particular welded thereon. A tie-down strap can be arranged on the respective lashing ring 10, by means of which the vehicle 1 can be lashed to the means of transport, in particular to its loading surface. For reasons of clarity, FIG. 2 shows only the device 9 arranged in the central opening 3 of the vehicle wheel 2 in an aerial view of the external side 5 of the vehicle wheel 2.

The fixing arrangement 11 of the device 9 comprises the retaining plate 12 already mentioned, and additionally a carrier 13, a threaded rod 14, a clamping cone 15 and at least two locking elements 16.

The carrier 13 is designed such that it can be inserted in a form-fit manner from the external side 5 of the vehicle wheel 2 into the hub cap receptacle 4. It has a central passage opening 17 for receiving the threaded rod 14, which is guided through the carrier 13.

The retaining plate 12 has a central screw opening 18 for screwing in the threaded rod 14. For this purpose, this screw opening 18 has an inner thread corresponding to an outer thread of the threaded rod 14.

The clamping cone 15 is arranged on the threaded rod 14, in particular outwards in the axial direction of the central opening 3 in front of a head 19 of the threaded rod 14, so that it is held by this head 19 on the threaded rod 14.

In order to fix the device 9 to the vehicle wheel 2, the clamping cone 15 having the threaded rod 14 and the locking elements 16 are arranged in the central opening 3 of the vehicle wheel 2 . In this case, the clamping cone 15 and the locking elements 16 are in particular arranged in the region of the central opening 3 adjoining the hub cap receptacle 4 in the axial direction. The threaded rod 14 protrudes outwards through the central opening 3, i.e., it protrudes beyond the external side 5 of the vehicle wheel 2, in particular of the wheel rim 8. The carrier 13 is slid on and inserted into the hub cap receptacle 4. The retaining plate 12 is then screwed onto the threaded rod 14. The carrier 13 is thus fixed in the hub cap receptacle 4, and protects the wheel rim 8 of the vehicle wheel 2 against damage, because the retaining plate 12 which rotates while being screwed on does not come into contact with the wheel rim 8, but only with the carrier 13.

In particular, if this protection of the wheel rim 8 is not required, in another embodiment, it can also be provided that the lashing ring 10 or the respective lashing ring 10 is directly fixed, in particular welded, to the carrier 13, i.e., to its carrier external side facing away from the axle of the vehicle 1, and the carrier 13, in its passage opening 17, has the inner thread corresponding to the thread of the threaded rod 14, so that the carrier 13 can be screwed onto the threaded rod 14. The carrier 13 then additionally takes over the tasks of the retaining plate 12.

By screwing the retaining plate 12 on or, in the other embodiment, by screwing on the carrier 13, the threaded rod 14 is pulled outwards, i.e., in the direction of the external side 5 of the vehicle wheel 2, and in the process also pulls the clamping cone 15 in this direction, in particular by means of its head 19. The locking elements 16 are arranged between the clamping cone 15 and an inner diameter-reducing recess 20 of the central opening 3 of the vehicle wheel 2 in this central opening 3, and are thus pressed radially outwards through the clamping cone 15 in the central opening 3, and additionally against this diameter-reducing recess 20, until they abut against this diameter-reducing recess 20 and against an inner opening wall of the central opening 3.

If this is the case, as schematically depicted in FIG. 1, the device 9, in particular the fixing arrangement 11, is braced on the vehicle wheel 2, i.e., is arranged in a form-fit manner in the central opening 3 and fixed therein. The carrier 13 sits in the hub cap receptacle 4, and the retaining plate 12 having the at least one lashing ring 10, if provided, abuts against the carrier 13 and is fixed to the vehicle wheel 2 via the threaded rod 14 and the fixing arrangement 11. In the other embodiment described above without the retaining plate 12, in which the at least one or the respective lashing ring 10 is arranged on the carrier 13, the carrier 13 is correspondingly fixed to the vehicle wheel 2 via the threaded rod 14 and the fixing arrangement 11.

In order to enable the described fixing to the vehicle wheel 2, the locking elements 16 respectively have an inner wall 21, which is designed, in particular aligned, to correspond to a frustoconical lateral surface 22 of the clamping cone 15. A diameter of the clamping cone 15 increases from a side facing the external side 5 of the vehicle wheel 2 to a side facing the internal side 7 of the vehicle wheel 2, such that the frustoconical lateral surface 22 of the clamping cone 15 is aligned correspondingly, in particular is inclined in the direction of the external side 5 of the vehicle wheel 2.

The locking elements 16 respectively have an outer wall 23, which is designed to correspond to the inner opening wall of the region of the central opening 3 of the vehicle wheel 2 adjoining the hub cap receptacle 4 in the axial direction, in particular designed to correspond to the wall of the diameter-reducing recess 20 in this region. It is in particular provided that a sum of a largest external diameter of the clamping cone 15 and of the, in particular radial, widths of the two locking elements 16 is greater than a smallest internal diameter of the central opening 3 of the vehicle wheel 2. In the example depicted, this smallest internal diameter is present at the diameter-reducing recess 20 of the central opening 3.

The functionality described above, i.e., the pressing of the locking elements 16 by means of the clamping cone 15 against the diameter-reducing recess 20 and against the inner opening wall of the central opening 3, is thus ensured, such that the fixing arrangement 11, and thus the entire device 9, is wedged in the central opening 3 of the vehicle wheel 2, and thus fixed in a form-fit manner to the vehicle wheel 2.

In the depicted example, the threaded rod 14 has an ejector recess 24, of which the diameter is greater than a diameter of a central receiving opening 25 in the clamping cone 15 for the threaded rod 14. The clamping cone 15 is arranged between the head 19 and the ejector recess 24 on the threaded rod 14. The ejector recess 24 thus makes it possible to push back the threaded rod 14 to remove the device 9, i.e., in the direction of the vehicle 1, and thus in the direction of the clamping cone 15, and thus to release the clamping cone from the locking elements 16. This makes it easier to release the clamping cone 15 and the locking elements 16 clamped by the latter in the central opening 3 of the vehicle wheel 2.

In this embodiment, to be able to arrange the clamping cone 15 on the threaded rod 14, it is for example provided that the threaded rod 14 and/or the clamping cone 15 is/are designed in two parts, at least before the clamping cone 15 is arranged on the threaded rod 14. In the case of the threaded rod 14, a division plane, for example, runs transverse to the threaded rod 14 between its ejector recess 24 and head 19 and/or, in the case of the clamping cone 15, along its receiving opening 25. After the clamping cone 15 is arranged on the threaded rod 14, the connection of the two parts can then for example be implemented in an integrally bonded manner, for example by welding, and/or in a form-fit manner, for example by screwing and/or latching, and/or in a force-fit manner. The form-fit and/or force-it connection make it possible to remove the clamping cone 15 from the threaded rod 14 without causing damage. However, because this is probably not required, the integrally-bonded solution presents itself as a particularly simple and stable solution.

1. -8. (canceled)

9. A device (9) for lashing a vehicle (1) to a loading surface, comprising:
at least one lashing ring (10); and
a fixing arrangement (11) for fixing the at least one lashing ring (10) to a hub cap receptacle (4) of a vehicle wheel (2) of the vehicle (1) in a form-fit manner;
wherein the fixing arrangement (11) has:
a carrier (13) which is configured such that the carrier (13) is insertable in a form-fit manner into the hub cap receptacle from an external side (5) of the vehicle wheel (2) and which has a central passage opening (17);
a threaded rod (14), wherein the threaded rod (14) is receivable in the central passage opening (17);
a clamping cone (15) disposed on the threaded rod (14);
a retaining plate (12), wherein the at least one lashing ring (10) is fixed to the retaining plate (12) and wherein the retaining plate (12) has a central screw opening (18) for screwing in the threaded rod (14); and
at least two locking elements (16);
wherein each of the at least two locking elements (16) respectively have:
an inner wall (21) which is configured to correspond to a frustoconical lateral surface (22) of the clamping cone (15); and
an outer wall (23) which is configured to correspond to an inner opening wall of a region of a central opening (3) of the vehicle wheel (2) adjoining the hub cap receptacle

(4) in an axial direction.

10. The device (9) according to claim 9, wherein the at least one lashing ring (10) is welded to the retaining plate (12).

11. The device (9) according to claim 10, wherein a sum of a largest external diameter of the clamping cone (15) and of respective widths of the at least two locking elements (16) is greater than a smallest internal diameter of the central opening (3) of the vehicle wheel (2).

12. The device (9) according to claim 9, wherein the threaded rod (14) has an ejector recess (24) with a diameter that is greater than a diameter of a central receiving opening (25) in the clamping cone (15) for the threaded rod (14).

13. The device (9) according to claim 9, wherein the at least one lashing ring (10) comprises two lashing rings (10).

14. The device (10) according to claim 13, wherein the two lashing rings (10) are fixed to the retaining plate (12) rotated by 90°relative to each other.

15. The device (9) according to claim 9, wherein the device is formed from metal.

16. A vehicle (1), comprising:
the device (9) according to claim 9.
